(19) United States
(12) Patent Application Publication
(10) Pub. No.: US 2018/0133552 A1
(43) Pub. Date: May 17, 2018

(54) Fitness training system by which a user can create his own personalized fitness training program

(71) Applicants: Anthony Jagroop, The Hague (NL); Annick Maria Teresia Teeuwen, The Hague (NL)

(72) Inventors: Anthony Jagroop, The Hague (NL); Annick Maria Teresia Teeuwen, The Hague (NL)

(21) Appl. No.: 15/808,923

(22) Filed: Nov. 10, 2017

Related U.S. Application Data
(60) Provisional application No. 62/423,222, filed on Nov. 17, 2016.

(51) Int. Cl. A63B 24/00; G06F 17/30

(52) U.S. Cl. CPC A63B 24/0075; A63B 24/0062; A63B 2024/0065; A63B 2024/0081; G06F 17/30828

(57) ABSTRACT

A (online) fitness training system with which a user (common user, health or fitness professional) creates/generates personalized fitness training/workout programs (online). By selecting individual exercises videos out of a database. During this selection process the user is assisted by an online assistant program which helps the user to create a complete workout video. The selected individual exercise videos are placed in a online video generator system which generates one complete workout video from the individual selected exercises videos. A user can communicate and exercise simultaneously with other users all over the world.

### CROSS-REFERENCE TO RELATED APPLICATION

We claim the benefit of one earlier filed provisional application, with application number U.S. 62/423,222, filing date Nov. 17, 2016, with conformation number 9705.

### FIELD OF THE INVENTION

With this invention, an affordable and creative fitness training system is provided via a website and an app. The essence of this invention is that each individual user is the director of his own fitness training program or that of others (clients, friends and family), by managing personal and family web pages, by selecting and sharing recorded complete instruction and exercise videos and by creating (a) complete personalized instruction and/or exercise video. The system learns and assists the user to create (a) personalized instruction and/or exercise videos. The user (or a third party, such as a (personal) trainer, friend or family member), fills a number of preconditions (e.g. muscles to exercise or not to exercise or the duration of the training) and selects the desired individual instruction or exercise videos from a database. While choosing the videos, the system assists the user to compile a complete personalized fitness training video by giving the user options of videos to select. When the selection is completed, the user gives the online video generator the instruction to generate a complete personalized video. The integrated online video generator combines the selected individual videos into a complete video and places it into the personal videos database of the user. With the personalized video, the user can responsibly (learn to) exercise by himself or simultaneously with others.

### BACKGROUND OF THE INVENTION

The invention originated from the idea that everyone should have the opportunity to live a fit and healthy life and a healthy lifestyle must be accessible and affordable for everyone. This invention gives people the knowledge and skills to be able to decide how, when, where, and especially the manner in which they exercise.

Looking at the world, the majority of mankind is not able to live a healthy and fit lifestyle, because of (the lack of) time or knowledge, the (high) costs or physical or psychological reasons.

According to The US Department of Health & Human Services, adults should engage in at least 150 minutes per week in aerobic physical activities of a moderate intensity or 75 minutes a week of heavy intensity activities. These guidelines are based on the significant health benefits a human can have by performing these amount of activities. Research has shown that only 20 percent of American adults are able to follow these guidelines. Especially groups with lower incomes and less education can't consume healthy food and exercise enough.

There are numerous services and resources available to help people to lead a healthy and fit life. Gyms, television shows, live streaming, websites, apps, YouTube Channel, books, magazines and not to mention personal trainers and other health, nutrition and fitness specialists. As an uninformed human being it is a challenge to make the right choices from the enormous supply on the internet and to be able to pay for it. The existing services and resources are not appropriate for every human being:
Gyms can be a high-threshold,
specialists can be expensive,
TV programs and live streaming broadcast at fixed times.
As the supply of videos (via YouTube), DVDs, television programs and live streaming are concerned, these are conceived and produced from the point of view, knowledge and mindset of the trainer or specialist. The specialist thinks thereby in a large group of practitioners and therefor produces an exercise or training video, of a certain length with certain exercises consisting of a number of sets of repetitions, in order to have a range as wide as possible.
The videos are not customized to the goals of an individual, to his level, requirements and any physical limitations.

This invention provides a professional, broad, accessible and affordable solution for a number of barriers that people may have.

There are two patents that relate to the manufacture and/or use of a personalized training video. US20050197 focuses on the personal trainer who produces personalized videos for his client. US 20090047644 focuses on the production of a personalized training video by the use of an avatar.

There is no website or app available that uses an integrated online video generator directly online to generate a personalized instruction or training video, consisting of a number of separate exercises videos, selected by a user from a database, in which process the user is guided by a system to construct a complete instruction or training video. And wherein the system places the generated instruction of training video in a personal videos database, which is specially equipped for the individual user and is managed by the individual user.

No patent, published idea or system offers the possibility, as presented in this invention, to an individual to lead a healthy and fit life by being the director of his or her fitness training program.

### BRIEF SUMMARY OF THE INVENTION

The user has access to the invention via an online platform, a website and an application (app). On the platform there the user has the possibility to create an individual account or an account as a professional. With a professional account, for example, (personal) trainers can compile instruction or exercise videos for their clients.

The user compiles, using the selection system, a personalized instruction or exercise video, by selecting individual videos from a database, that fits the needs of the user. The user can pre-fill a number of conditions that the selection system takes into account.

The selection system assists the user, while selecting the videos out of the exercise videos database, by giving different options of videos that the user can select. For example, if the user wants to focus on developing the abdominal muscles, the user can indicate this as a precondition. The selection system will then show the possible videos of exercises for the abdominal muscles which the user can select. The selection system will continue offering options until the user gives the system the command to generate a full instruction or exercise video. The online video generator then generates a full video of all the individual videos that the user has selected. The full video is then placed directly after generating in the vicinity (a personal videos database) of the user.

The user can view the videos as instructions to learn how the exercises should be performed correctly or he uses the video to work out just by doing the exercises that are shown on the video.

The platform combines the offering of personalized training videos with social media and nutrition.

To keep his or another user's (this can be a complete stranger or a friend of family member) motivated and committed, the user has the possibility to communicate, visually and aurally, online with other users and he can exercise with them. The user can share videos with other users. They can play that shared video simultaneously in order to exercise together.

In addition to the ordinary user, (personal) trainers, health professionals and sports centers can use the platform to provide trainings to their clients.

Trainers have the tools to train their clients online. They can register their clients, enter their personal data and goals, give nutritional advice and create a personalized training video by using the online video generator. They can place the generated videos into the personal videos database of the clients.

Sports Centers can, if they have a television or screen with internet connection and a workout space, use this system to train their clients. They can create a new workout video at any time using the online video generating system. This gives them the opportunity to make a video for each targeted group.

### BRIEF DESCRIPTION OF THE DRAWINGS

FIG. 1 shows the systems or processes how a user enters the website via an URL to reach the website homepage. He can log in as a professional or as ordinary user to get to his personal page or log in on the app.

FIG. 2 shows the systems or processes of the personal web page of the user and the individual systems he can address through his personal web page.

FIG. 3 shows the systems or processes with which a personalized fitness training video is generated. The database of instruction and exercise videos and the system supporting the user while compiling a personalized video. The online video generator system and the system that attaches standard preprogrammed contents automatically when a video is generated. And the system that stores the generated video automatically in the personal videos database (FIG. 4) of the user.

FIG. 4 shows the systems or processes of the personal videos database of a user. Which systems fills the personal videos database with videos and which systems a user can address through the personal videos database system.

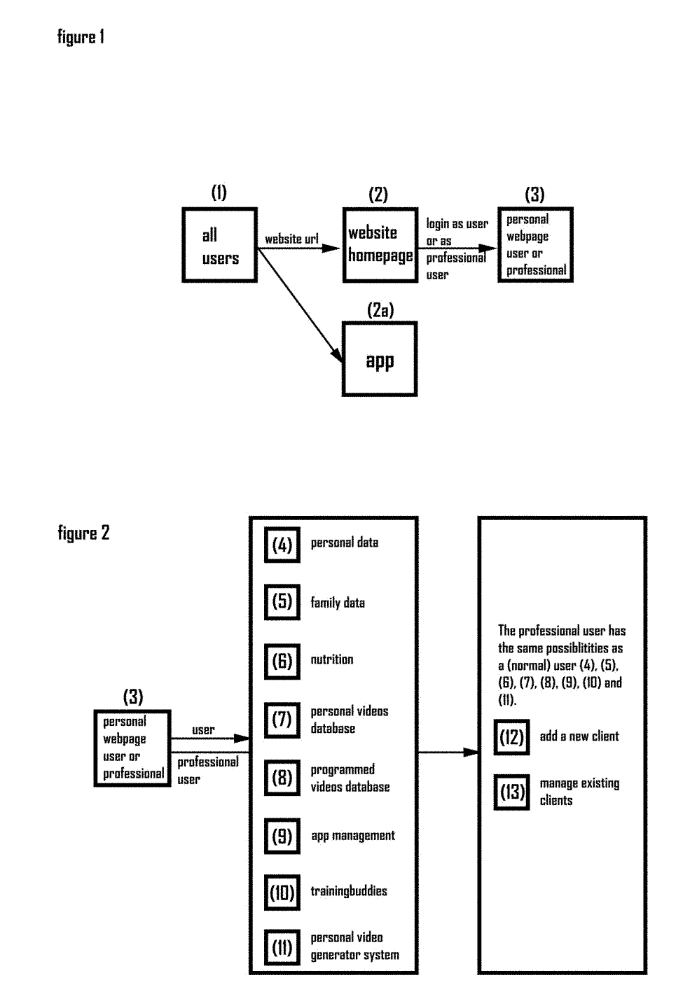

FIGS. 1, 2, 3, and 4 together is a representation of all the systems of the invention.

### DETAILED DESCRIPTION OF THE INVENTION

The working of this invention is set put by reference to the attached Drawings of FIGS. 1 to 4. FIG. 1:

All users (1) use the website URL to get on the website homepage (2). On the website homepage the user finds general information about health and a fit lifestyle, movement, nutrition, instructions how to join, the functionalities of the website and the app (2a), information on the use and management of the personal web page, the working of and use of the personal video generator system, the use of the exercise videos database, the working of the exercise videos selecting system, how the user can come into contact with another users (training buddies), how they can share videos and exercise together. And finally, the user has the possibility to log in as the ordinary user or as a professional. Once the user is logged in (as a member), the system directs him to his personal web page (3).

FIG. 2:

When the user has logged in he gets on his personal web page (3). The personal webpage has been specially programmed for the individual user, which he manages completely independently.

He fills his personal data (4), objectives and data as weight, age, injuries, sports history and other preferences.

Under family data (5) several family members can be included. Idea is that you can lead a healthy lifestyle with your entire family. And anyone can fulfill a pioneering role to achieve this. You can motivate, encourage and most important exercise together. You can create an instruction or exercise video for a family member and place this in his personal videos database (7). For example, a mother has the possibility to exercise alone, but can also exercise with her partner, mother, daughter or son. To stimulate each other a competitive/game element is included, allowing family members to compete with each other to reach certain defined goals, for example, the first family member to achieve a particular weight loss.

Under nutrition (6) user fills in his diet and objectives. The user gets nutritional advice and a user can create a nutrition plan or receive a nutrition plan from a professional.

Each logged in user has a personal videos database (7). The personal videos database system is the repository of all, by user, by another or by the system, added, shared, selected and composited videos. Videos are placed in the personal videos database of a user in different ways.

Videos that the user has compiled with the personal video generator system (11). Videos selected by the user from the programmed videos database (8). Videos composed or selected for the user by a professional, a family member or training a buddy. And a number of standard videos that the system places by default setting in the personal videos databases of all users. The options available to a user through the personal videos database (7) are described in detail under FIG. 4.

Out of the programmed videos database (8) a user selects complete instruction or exercise videos that are compiled by a certified professional. Different trainings for different purposes, periods of time, age groups and levels. Videos selected by the user from the programmed videos database (8) are automatically placed in the personal videos database (7) of the user.

Under App Management (9) the user manages the app. Through the app the user gets notifications to exercise and for nutrition. The user can select a video from his personal videos database (7) to play through the app.

Under training buddies (10) a user can connect with other users and communicate with each other online and they can exercise together. The intent of this system is that you can motivate and encourage each other by connecting and exercising online. And also for example a mother can connect a training buddy to her child. Children can motivate each other to exercise. There are many people who are alone and can't stay motivated to achieve certain objectives. This system provides the social and motivational aspect of the entire training system. With the cam system (18) users can see and hear each other during a workout and users can do the same workout because they can share videos and they can play a shared video simultaneously.

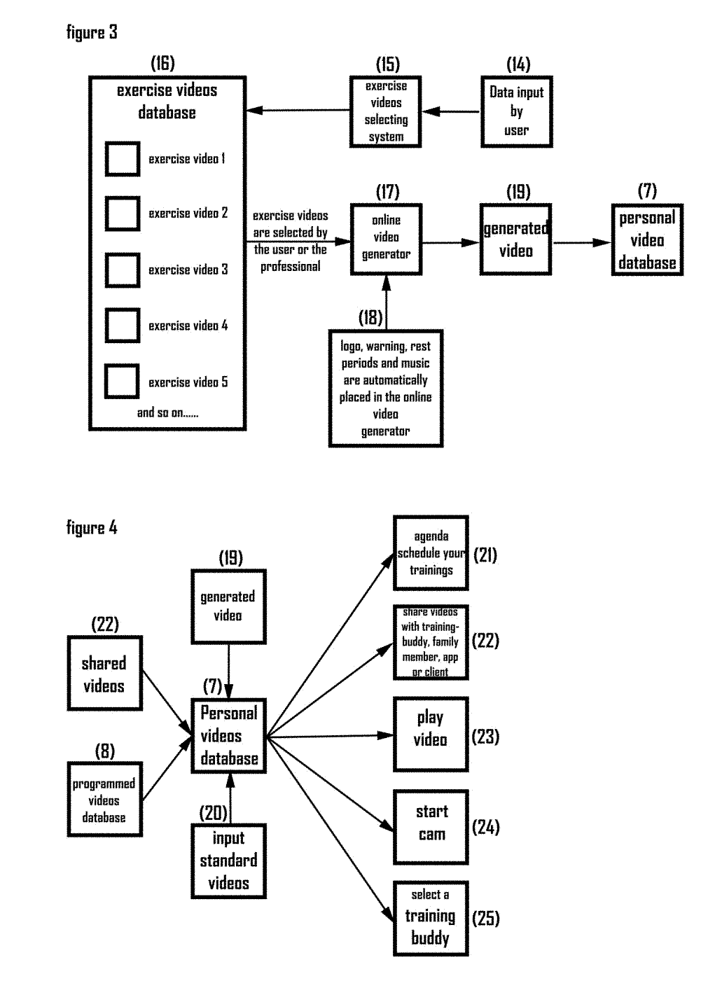

By using the personal video generator system (11), the user can compile his own personalized video. The working of the personal video generator system will be described in detail under FIG. 3.

The professional is any (certified) person in the health and fitness industry. The system is not only for personal trainers or fitness professionals but also for coaches/trainers in all fields of sports, for example a soccer, baseball, football or basketball coach. They can create a personalized workout for each team member. And this system is for any health professional, such as a Physiotherapist, who can create personalized workout programs for his/her clients. The professional has the same opportunities as all users, as described under (4), (5), (6), (7), (8), (9), (10) and (11). Besides that, he can create a new clients (12) and manage existing clients (13). He can compose personalized instruction or exercise videos for all clients using the personal video generator system (11) and place the composed videos in their personal videos database (7). He can choose complete instruction or exercise videos from the programmed videos database (8) and place these videos into personal videos database (7) of his clients. He can watch his clients and communicate during their workouts via the cam system (18). He can give his clients dietary recommendations and plans using the nutrition system (6). He can recommend a training buddy to his client using the training buddies system (10). He can let clients exercise together by connecting them and share the same instruction or exercise video, which they can play simultaneously to exercise.

FIG. 3:

The personal video generator system (11) is where all users compose their own personalized instruction or exercise video.

The user can pre-fill several conditions (14). For example, the user can indicate which muscle groups he wants to exercise, which muscles he doesn't or can't exercise and what length the composed video may be. The completed data is fed to the exercise videos selecting system (15) that processes the data and used when providing selection options when the user is composing his own personalized video.

The exercise videos database (16) is an essential component of the personal video generator system (11). From the exercise videos database the user selects the several individual instruction or exercise videos that he wants to generate into an complete/serried video. The videos in this database are recorded by certified professionals or with the aid of people under the supervision of certified professionals. The exercise videos database offers different types of instruction or exercise videos, an individual instruction or exercise video can contain:

1. an individual exercise (e.g. crunch, a stretch or burpees)
2. a combination of exercises (e.g. crunch and burpees)
3. an individual exercise or combination of exercises based on time or on number of repetitions
4. an explanation of an individual exercise or a combination of exercises
5. an individual exercise with body weight or with attributes such as a dumbells, a bosu ball or a dynaband
6. a sport-specific exercise or series of exercises
7. an individual exercise or series of exercises in Yoga, Tai Chi, Pilates, fitness and other fields of sports or movements

The exercise videos database contains hundreds of exercises and is expandable. When possible the videos in the exercise videos database are filmed in a specific manner so that they flow into each other when they are generated into complete/serried video by the online video generator (17). The user can select from the exercise videos database by a drag & drop or a shopping cart system that automatically places the selected videos in the online video generator. Each video of the exercise videos database are displayed on the web page in a way that a user can see how the exercise is performed. A user can also select an exercise directly to get the full explanation of the selected exercise.

The exercise videos database (16) is supported by the exercise videos selecting system (15), that supports the user when making choices from the videos he can select. It is an unique system tailored to the needs and goals of the user. The user has previously completed a number of conditions (14). The exercise video selecting system uses these conditions and helps the user when compiling a complete instruction or exercise video. The exercise videos selecting system displays (pops up) when the user begins with selecting videos from the exercise videos database (14). It gives the user options (as supplements) of videos to select, in order to generate a full workout video. As examples:
If a user selects a number of exercises for the arm (muscles), then the exercise video selecting system displays options of exercises (videos) for other body parts or other muscle groups.
If the user has specified a certain maximum duration of the video, the exercise video selecting system displays the time that needs to filled and gives options of exercises that the user can select.
If a user did not select a warming up, cooling down or stretch exercises, then the exercise video selecting video displays these exercises for the user to select.
If a user has specified as a boundary condition that he would work the arm muscles, then the exercise video selecting system options displays options of exercises for these muscles.

The exercise videos selecting system will be active assisting the user until the user gives the online video generator (17) the command to generate a full video.

The online video generator (17) generates, from all of the selected individual videos, one complete instruction or exercise video (19) and places it in the personal videos database (7) of the user.

In the entire process, as described in this patent application, the online video generator (17) needs to be specially programmed and has to be implemented on or into the website to be able to function in this unique manner, wherein multiple users can therefore generate a plurality of videos, directly online, which are then placed in their personal videos database (7).

The online video generator (17) is powered by a system (18) which automatically adds several standard information like a logo, rest periods, a warning, a liability waiver and music in the generated video (19).

FIG. 4

The personal videos database of a user is filled with videos that other users, including a professional, shares with the user (22). A generated video (19) is automatically placed into the personal videos database. The system automatically adds standard videos (20) into the personal videos database of a user. And videos selected by the user out of the programmed videos database (8) are added into the personal videos database of the user.

From the personal videos database (7) a user manages his agenda (21). The agenda is programmed to provide alerts, through the website, e-mail address or the app, when a user needs to train, eat and drink.

The share videos system (22) gives the user the opportunity to share a video of his personal videos database with others (training buddies or family members) and he can place a certain video in the app so that the user can watch it on the app. The professional may share videos from his personal videos database to the personal videos databases of users he has as clients.

From the personal videos database the user can play a video (23) to learn or to exercise. By using the cam system (24) the user activates the camera (a loose camera or the one on his computer, television, laptop, tablet or phone). By using the select a training buddy system (25) the user selects a training buddy, with whom the user can exercise. With the cam system the user can see, hear and exercise with his selected training buddy during collectively playing the same video. The cam system (24) is used by professionals to advise and train clients.

1. A multimedia personal fitness training system to create and manage a personalized fitness training program, comprising:
A. A website with multiple (individual) web pages (environment).
B. An app (environment).
C. A computer, laptop, TV, tablet, phone or other device that can connect to the website and/or the app.
D. An internet connection.
E. Multiple users.
F. Multiple databases ((some) containing multiple (individual) instruction and/or exercise videos) that are integrated, a part of and/or connected to the website and/or the app.
G. Multiple computer (software) programs/systems that are integrated, a part of and/or the invention of claim 1, further comprising a computer (software) program/system (defined in the drawings as personal web page) by which or wherein a user logs in as an ordinary user or as a professional user (personal trainer, health or fitness specialist) to get access to his personal webpage. By which or wherein a user manages his personal webpage and by which or wherein a user accesses other computer (software) programs/systems from his personal webpage.

2. The invention of claim 1, further comprising a computer (software) program/system (defined in the drawings as personal data) by which or wherein a user manages his personal information (e.g. age, gender, weight, goals), By which or wherein a user fills in, complements, changes or deletes his personal information.

3. The invention of claim 1, further comprising a computer (software) program/system (defined in the drawings as family data) by which or wherein a user registers, manages, fills in, changes, complements or deletes data/information of one or more family members or relatives. By which or wherein family members fills in certain goals they want to achieve after a certain period (e.g. a certain amount of weight loss they want to achieve in a certain period, or a number of exercise they want to complete after a certain period or a specific duration of training they want to achieve after a certain period). By which or wherein family members can compete against each other to achieve defined goals after a defined period. By which or wherein the achievements/progress of the family members are tracked and processed. By which or wherein the family member who has achieved his defined goals as the defined period has ended or is the closest to achieving his defined goals as the defined period has ended is rewarded. This computer (software) program/system gives users the opportunity to motivate and to exercise with other members of his family. One member of a family can be the stimulator for the entire family to live a healthy and fit lifestyle.

4. The invention of claim 1, further comprising a computer (software) program/system (defined in the drawings as nutrition) by which or wherein a user fills in, stores and manages nutrition information. By which or wherein a user composes or adds a diet plan and receives a diet plan from another user or a professional.

5. The invention of claim 1, further comprising a computer (software) program/system and/or a database (defined in the drawings as personal videos database) by which or wherein (complete) instruction or exercise videos are stored. By which or wherein a user manages, stores, watches, deletes and/or shares videos with other users (including family members and training buddies mentioned by claims 8 and 17). By which or wherein a professional user shares videos with his clients.

6. The invention of claim 1, further comprising a computer (software) program/system by which or wherein standard complete instruction and exercise videos are stored (automatically) in the personal videos database, as mentioned by claim 5, of a user.

7. The invention of claim 1, further comprising a computer (software) program/system and/or a database (defined in the drawings as programmed videos database) by which or wherein (complete) instruction and/or exercise videos are stored. By which or wherein a user selects (these) complete instruction and exercise videos. By which or wherein (these) selected complete instruction and exercise videos are (automatically) placed in de personal videos database, as mentioned by claim 5, of the user.

8. The invention of claim 1, further comprising a computer (software) program/system (defined in the drawings as training buddies) by which or wherein a user indicates he wants to connect with other users to communicate, aurally and visually, and to exercise. By which or wherein a user connects with other users to communicate and to exercise. By which or wherein a user can see and hear another user. By which or wherein a professional user connects users (clients) with/to each other. By which or wherein a user connects users with/to each other. By which or wherein a professional connects and communicates aurally and visually with his clients.

9. The invention of claim 1, further comprising a computer (software) program/system (defined in the drawings as personal video generator system) by which or wherein a user accesses the personal video generator system and by which system a user creates or compiles a personalized instruction or exercise video with the online video generator, mentioned by claim 10.

10. The invention of claim 1, further comprising a computer (software) program/system and/or a database (defined in the drawings as online video generator) by which or wherein an online video generator (system) is fully integrated into the website/web page. By which or wherein the, by the user, selected (individual instruction and/or exercise) video(s), out of the exercise videos database mentioned by claim 11, are/is (automatically) stored in the (database of) the online video generator (system). By which or wherein a complete instruction and/or exercise video is generated/rendered by the online video generator out of the, by the user, selected, individual instruction and exercise, video(s) out of the exercise videos database mentioned by claim 11. By which or wherein (automatically) a logo, a warning text, rest periods and music, is integrated into the generated complete instruction or exercise video. By which or wherein the generated instruction or exercise video is (automatically) placed in the personal videos database, as mentioned by claim 5, of the user. The online video generator is a video generator or rendering system that generates/renders loose or individual video components/fragments into one complete/compact/serried video. In this invention as mentioned the online video generator is fully implemented into the website to fulfil these functionalities.

11. The invention of claim 1, further comprising a computer (software) program/system and/or a database (defined in the drawings as exercise videos database) by which or wherein individual instruction and/or exercise videos are stored. By which or wherein (these) instruction and exercise videos are displayed individually on the web page of the personal video generator system as mentioned by claim 15. By which or wherein these instruction and exercise videos are displayed in a manner that the user can see which exercise or combination of exercises is/are performed. By which or wherein a user selects the option to get explained how an exercise must be performed. By which or wherein the selected explanation video is (dis)played. By which system the user selects these (individual) instruction and exercise videos to be generated into a complete instruction or exercise video, by the online video generator as mentioned by claim 10. By which or wherein the, by the user, selected, instruction and/or exercise, video(s) are/is automatically placed/stored in the online video generator database/system as mentioned by claim 10.

12. The invention of claim 1, further comprising a computer (software) program/system and/or a database (defined in the drawings as exercise videos selecting system) by which or wherein individual instruction and/or exercise videos are stored. By which or wherein user is supported/assisted while compiling a personalized instruction or exercise video. By which or wherein individual instruction and exercise videos are displayed as options to select, when a user uses the personal video generator system (web page) as mentioned by claim 9, to compile a complete/serried/compact instruction or exercise video by the online video generator as mentioned by claim 10. By which or wherein individual instruction and exercise videos are displayed as options as a user starts to select an instruction or exercise videos out of the exercise videos database as mentioned by claim 11. By which or wherein the user is offered options of instruction or exercise videos that supplement or complement the selections that he has already made out of the exercise videos database, to assist him to generate a complete instruction or exercise video containing a complete fitness training. By which or wherein the data input, mentioned by claim 13, is processed into options of instruction or exercise videos that can be selected by the user. By which or wherein options of instruction or exercise videos to select are continuously displayed until the user gives the online video generator, as mentioned by claim 10, the instruction to generate a complete/serried/compact instruction or exercise video.
A number of examples given to explain the working of this computer (software) program/system:
If a user selects a number of exercises for the arm (muscles), then the exercise video selecting system displays options of exercises (videos) for other body parts or other muscle groups.
If the user has specified a certain maximum duration of the video, the exercise video selecting system displays the time that needs to filled and gives options of exercises that the user can select.
If a user did not select a warming up, cooling down or stretch exercises, then the exercise video selecting video displays these exercises for the user to select.
If a user has specified as a boundary condition that he wants to exercise the arm muscles, then the exercise video selecting system displays options of exercises for these muscles.
The exercise videos selecting system is specially programmed to help a user to compile a complete fitness training video.

13. The invention of claim 1, further comprising a computer (software) program/system (defined in the drawings as data input) by which or wherein a user enters data containing information which muscles a user wants during exercise, or which muscles a user doesn't want to use during exercise or the maximum length of the instruction or exercise video that will be generated by the online video generator system. By which or wherein the entered data is integrated into and processed by the exercise videos selecting system as mentioned by claim 12.

14. The invention of claim 1, further comprising a computer (software) program/system (defined in the drawings as share videos). By which or wherein a user shares multiple instruction or exercise videos with other users, family members and vice versa. By which system a shared video is placed in the personal videos database, as mentioned by claim 5, of the user. By which or wherein a user places (an) instruction or exercise video(s) in the app to be watched/played.

15. The invention of claim 1, further comprising a computer (software) program/system (defined in the drawings as play video) by which or wherein a media player is integrated into the website/web page, by which a user plays/watches an instruction or exercise video.

16. The invention of claim 1, further comprising a computer (software) program/system (defined in the drawings as select Cam) by which or wherein the user activates (a) (any) (integrated) cam and microphone (during playing a video). By which system a user sees, hears and communicates with another user that he has selected to be his training buddy mentioned by claim 17.

17. The invention of claim 1, further comprising a computer (software) program/system (defined in the drawings as a training buddy). By which a user selects another user (a training buddy) while playing a video to communicate (see and hear) and exercise with.

18. The invention of claim 1, further comprising a computer (software) program/system by which multiple users plays/starts the/a same instruction or exercise video simultaneously with (an) other user(s). By which the users who are playing/watching a (shared) instruction or exercise video simultaneously (at the same time) can activate a microphone and/or a cam (of their Ipad, phone, computer, laptop or television), by which users can see and hear each other while playing the instruction or exercise video simultaneously in order to communicate and to exercise together watching the same instruction or exercise video.
